(19) United States
(12) Patent Application Publication
(10) Pub. No.: US 2001/0044903 A1
(43) Pub. Date: Nov. 22, 2001

(54) Information access method and network system

(75) Inventors: Tatsuyoshi Yamamoto, Soka-shi (JP); Takeaki Misawa, Chiba-shi (JP)

Correspondence Address: ARENT FOX KINTNER PLOTKIN & KAHN, PLLC, Suite 600, 1050 Connecticut Avenue, Washington, DC, 20036-5339, US

(73) Assignee: Sumitomo Heavy Industries, Ltd.

(21) Appl. No.: 09/853,778

(22) Filed: May 14, 2001

(30) Foreign Application Priority Data
May 12, 2000 (JP) 2000-140824

(51) Int. Cl. G06F 11/30

(52) U.S. Cl. 713/200

(57) ABSTRACT

A secured network system capable of easily constructing a groupware environment is offered. Host servers are placed within an intranet protected by a firewall. The host servers are connected with local servers located outside the intranet via a private network. At least some of files possessed by the host servers and the local servers are taken as common files whose contents are maintained in common with each other. Access to the common files in the host servers is allowed. The contents of the common files in the local servers can be gained from a cellular phone.

### BACKGROUND OF THE INVENTION

1. Field of the Invention

The present invention relates to a network system capable of easily constructing an environment where different groupware is realized for each different enterprise within a firewalled network and, more particularly, to techniques permitting external access to information treated by groupware by making use of cell phones, PDAs (personal digital assistants) using a PHS (Personal Handyphone System), or wireless mobile terminals such as notebook computers.

Groupware usually refers to computer software that assists works performed by a group of people having a common task or object. The groupware referred to herein means a concept including hardware resources for realizing this software.

2. Description of the Related Art

Businesses within enterprises have assumed varied forms. It is rare that a single person can complete a business work. Usually, plural persons coordinate to effect a business work using groupware. The groupware is accomplished, for example, by preparing an intranet protected by a firewall, connecting client terminals operated by employees of a company and a server with the intranet, and loading computer programs for imparting a user-interfacing function, a security function, and other functions to the server into the server that allows access from the client terminals under certain conditions.

Usually, a WWW (World Wide Web) server of an Internet provider is also connected with the intranet. With respect to electronic mails from external terminals, they can be exchanged with the inside of the intranet via the Internet.

In recent years, PDAs (personal digital assistants) capable of connecting with the Internet using wireline/wireless communications means, mobile terminals such as notebook computers, and cell phones having Internet connection functions and mailing functions have explosively spread. There is a trend towards using these mobile terminals and cell phones as terminals for Internet mail services and making active use of them in businesses of enterprises.

If a server is connected with an in-house intranet within an enterprise to manage in-house information about this enterprise, and if an environment in which the aforementioned various terminals can be connected with the server can be established, then the enterprise's personnel can gain access to the in-house information from any desired location at any time. This form of utilization is quite favorable for enterprise's businesses. However, current techniques have the following problems and it is difficult to put the aforementioned system into practical use.

(1) A sufficient level of security cannot be obtained.

Where in-house information is accessed based on the utilization of Internet mailing services, a WWW server of an Internet provider who has no duty of confidentiality is interposed. This is undesirable for security of in-house information.

(2) The running cost is high.

To secure communications security, it is conceivable to connect all various terminals for realizing groupware by dedicated communication lines or to connect the intranet of the head office of a company with the intranets of branch offices by dedicated communication lines and interconnect all the intranets of the head and branch offices by dedicated communication lines. However, this inevitably needs laying many dedicated communication lines, thus increasing the running costs drastically. Furthermore, cellular phones and other mobile terminals constantly vary in position and so it is unpractical to interconnect all of them by private lines. Note that a few companies can achieve a sufficient level of communications security by laying dedicated communication lines. Hence, techniques of this kind cannot be spread or improved.

(3) The operability is not good.

Service conditions set by a cellular phone service provider place limitations on Internet mailing services normally offered by the provider. The number of characters per email is limited. Also, the number of emails stored in the mail server is restricted. Furthermore, certain limitations are imposed on the form of attached documents and on other forms. Where groupware should be actively used within an enterprise, it is necessary to exchange electronic documents of large size. If existing Internet mailing services are used in businesses, each large document must be divided into smaller document parts. This involves cumbersome operations. In the case of cellular phones, manual operations necessary for mailing operations differ somewhat among different kinds of machine. This makes it difficult to perform unified education and training for manual operations.

(4) The expansibility is poor.

Heretofore, on receiving information via a cellular phone, a company's employee has manually activated an application program corresponding to the contents of the information. Furthermore, when a control signal is received from a wireline digital terminal, a computer offered by some wireline communications service provider has encoded the contents of the control signal and automatically activate and run one of previously registered application programs.

Today, however, it is not carried out to arbitrarily activate and run an originally prepared application program from a cell phone or the like without using the existing infrastructure offered by the above-described service provider.

### SUMMARY OF THE INVENTION

It is an object of the present invention to provide an information access method which solves the foregoing problems and is capable of easily constructing a practical secured environment for dedicated groupware.

It is another object of the invention to provide a network system adapted for the execution of this information access method.

In the present invention, an environment in which access can be implemented from the outside by unified manual operations is constructed within a network protected by a firewall. Servers located outside and inside the network are interconnected by private communication lines or virtual private communication lines, thus providing security. Files possessed by the servers are taken as common files. If necessary, a desired application program can be run from the outside. In this way, a practical environment for groupware is configured. By adopting this scheme, the foregoing problems are solved.

Access referred to herein embraces various instructions such as indications made by FAX and printing commands, as well as request for information and gaining of information.

An information access method that embodies the scheme described above in accordance with the present invention is characterized as follows. A first server is placed within a network protected by a firewall. A second server located outside the network is connected with the first server by a private communication line or a virtual private communication line. At least some of files possessed by the first and second servers are taken as common files whose contents are maintained in common with each other. Access to the common files in the first server is allowed. Inconsequence, an originator terminal or a source terminal that attempts gaining access can gain the contents of the common files in the second server.

Preferably, the first server has a Web mailing function. Web mails are exchanged between the first server and a wireless mobile terminal such as a cell phone having a Web mailing function by using the mobile terminal as an originator terminal.

In another information access method in accordance with the present invention, a first server capable of responding to access performed by a wireless mobile terminal is placed within a network protected by a firewall. A second server located outside the network is connected with the first server by a private communication line or a virtual private communication line. A given application program is loaded in the second server. In response to instructions given from the wireless mobile terminal and contained in access passed through the firewall, the second server activates and runs the application program and sends results of the execution of the program to the wireless mobile terminal via the first server.

Where the network has segments that are independent of each other, the first server are placed in each segment. Access passed through the firewall is directed to the first server specified by the contents of the access.

The network system that solves the foregoing problems in accordance with the present invention has the following variations.

A first network system has a network protected by a firewall. A first server capable of responding to access passed through the firewall is placed in a segment of the network. The segment has a connection port for connecting the first server with a second server located outside the network via a private communication line or a virtual private communication line.

At least some of files possessed by the first and second servers are taken as common files whose contents are maintained in common with each other. The first server is designed to search the common files of its own for information corresponding to the access and to send the fetched information to the originator terminal that implemented the access.

A second network system incorporates a network protected by a firewall. Independent segments and a communication control means for directing access passed through the firewall to any one of the segments are installed within the network. A first server capable of responding to the access is placed in each of the segments. Each of the segments has a connection port for connecting a second server located outside the network with the first server by a private communication line or virtual private communication line. At least some of files possessed by the first and second servers in each segment are common files whose contents are maintained in common with each other. The first server to which the access is directed searches the common files of its own for information corresponding to the contents of the access. The found information is sent to the originator terminal that implemented the access.

In the first or second network system, to maintain the contents of the common files in the first and second servers in common with each other, if the common files in one server vary, the differential data is sent to the other servers. If the differential data described above is received from other server, the differential data is automatically copied into the common files of its own.

A third network system incorporates a network protected by a firewall. A first server capable of responding to access passed through the firewall is placed in one of segments forming network. The segment has a connection port for connecting a second server located outside the intranet with the first server via a private communication line or virtual private communication line. A given application program is loaded in the second server. A command included in the access causes the second server to activate and run the application program. Information indicating the results of the execution is gained and sent to the originator terminal that implemented the access.

In a fourth network system, a first server of a user enterprise is placed within a network protected by a firewall. A second server of the user enterprise is located outside the network and connected with the first server by a private communication line or virtual private communication line. At least some of files possessed by the first and second servers are in-house information files of the user enterprise whose contents are maintained in common with all the servers. The network permits access from a wireless mobile terminal operated by an authorized person. The first server has copying means for executing a copying task for maintaining the in-house information files held in this server in common with the files in the second server. Furthermore, the first server has a means for carrying out at least one of processes: (1) receiving the contents of the permitted access and writing information into the in-house information files possessed by this server; (2) reading information from the contents of the permitted access and sending it out; (3) searching the files for desired information; and (4) reading or writing in-house schedule data from or into the in-house information files in this server. Communication with the wireless mobile terminal that provided the access is allowed.

In a fourth network system, a first server is further provided with a means for assisting exchange of information about in-house information files between employees of the user enterprise including the aforementioned authorized person, to efficiently run the groupware. For convenience of the person possessing a cell phone, the first server is further provided with a means for creating a mobile address book for extracting the addresses of a given number of persons from the in-house employee address book of the user enterprise and presenting the addresses on the cell phone.

As a preferable form of the fourth network system, the first server has a time-measuring means for measuring time. When the schedule processing is performed, data about only scheduled events later than the present date or the present time are subjected to the schedule processing. The aforementioned wireless mobile terminal is a cell phone having a Web mailing function. The first server has a Web mail server function and responds to access from the cell phone via a Web mail. Information about fee required for reception is displayed on the cell phone for each kind of information to be treated.

The preferred embodiments of the present invention are hereinafter described with reference to the drawings.

### BRIEF DESCRIPTION OF THE DRAWINGS

FIG. 1 is a block diagram of a network system in accordance with the present invention;

FIG. 2 is a diagram of a detailed example of an intranet;

FIG. 3 is a block diagram of one example of a router;

FIG. 4(a) is an NAT table loaded in a router located outside an intranet, and in which data is routed to a firewall from a public switched network;

FIG. 4(b) is an NAT table similar to FIG. 4(a), but in which data is routed from the firewall to the public switched network;

FIG. 5 is a block diagram of a host server using a Domino server, illustrating the functions of the host server;

FIG. 6 is a diagram illustrating the mechanism of a copying operation performed between a host server and a local server;

FIG. 7 is a flowchart illustrating a sequence of operations performed when addresses of about 10 individuals are copied from an in-house address book;

FIG. 8 is a flowchart illustrating a sequence of operations performed when a personal address book is copied into an email file;

FIG. 9 is a flowchart illustrating a sequence of operations performed when a company's employee gains access to a host server;

FIG. 10 is a flowchart illustrating a sequence of operations for reception processing;

FIG. 11 is a flowchart illustrating a sequence of operations for processing a received document;

FIG. 12 is a flowchart illustrating a sequence of operations for deleting processing;

FIG. 13 is a flowchart illustrating a sequence of operations for replying processing;

FIG. 14 is a flowchart illustrating a sequence of operations for forwarding processing;

FIG. 15 is a flowchart illustrating a sequence of operations for FAX processing;

FIG. 16 is a flowchart illustrating a sequence of operations for sending processing;

FIG. 17 is a flowchart illustrating a sequence of operations for search processing;

FIG. 18 is a flowchart illustrating a sequence of operations for displaying a search list;

FIG. 19 is a flowchart illustrating a sequence of operations for new keyword processing;

FIG. 20 is a flowchart illustrating a sequence of operations for schedule processing;

FIG. 21 is a flowchart illustrating a sequence of operations for creating a new schedule;

FIG. 22(a) is a view showing a LOGIN screen displayed on the viewing screen of a cell phone;

FIG. 22(b) is a view showing a main screen;

FIG. 22(c) is a view showing a screen displayed during reception processing;

FIG. 22(d) is a view showing another screen displayed during reception processing;

FIG. 22(e) is a view showing a screen for displaying a document;

FIG. 23(a) is a view showing a main screen, in which SEARCH is selected;

FIG. 23(b) is a view showing a screen displayed during search processing;

FIG. 23(c) is a view showing a screen for entry of a new keyword;

FIG. 23(d) is a view showing the results of the search made using the keyword;

FIG. 23(e) is a view showing a screen for displaying a document after the search;

FIG. 24(a) is a view showing a main screen, and in which SCHEDULE is selected;

FIG. 24(b) is a view showing a screen having a region on which a list of items of a schedule is shown;

FIG. 24(c) is a view showing a menu for creating a schedule;

FIG. 24(d) is a view showing the manner in which a user is prompted to enter data for creating a new schedule; and

FIG. 24(e) is a view showing the contents of a data entry region where COMMITTEE is called.

### DESCRIPTION OF THE PREFERRED EMBODIMENTS

Whole Structure

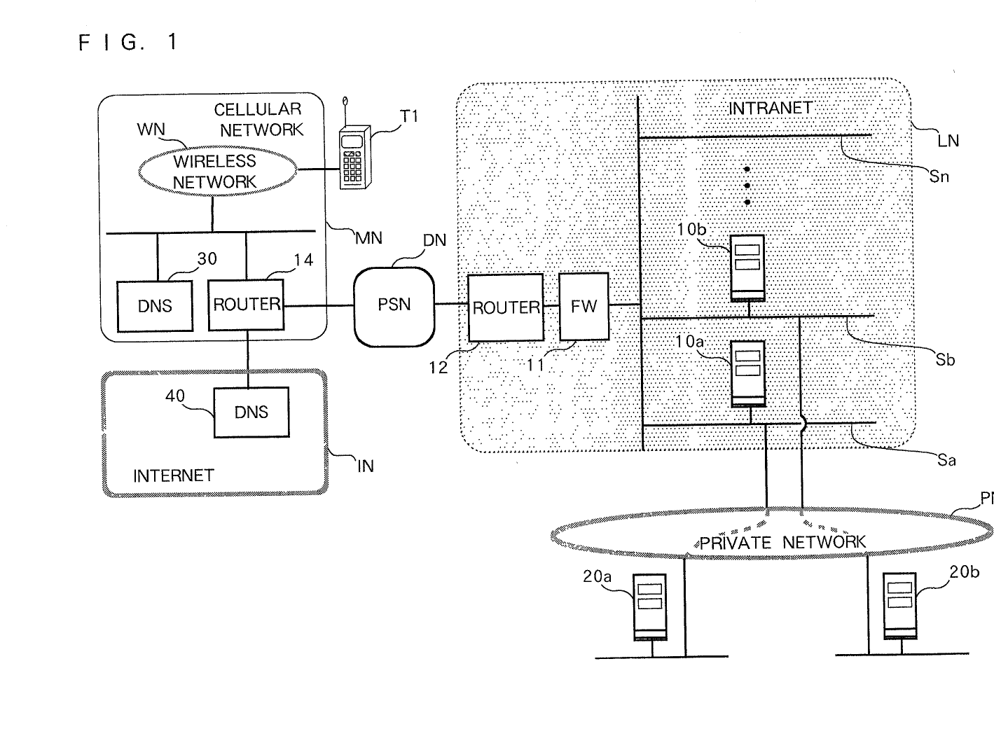

FIG. 1 shows the whole construction of a network system to which the present invention is applied. This network system is based on a secure intranet LN mounted in an administrative enterprise where a public switched network (PSN) DS is laid. A firewall (FW) 11 is placed at the entrance of the intranet LN having a plurality of segments Sa-Sn. Only certain accesses are permitted to pass through the firewall 11.

The intranet LN has the segments Sa-Sn that can be connected to a private network PN. User enterprises have host servers 10a, 10b, etc. which should be managed. The segments Sa-Sn are assigned to position these servers 10a, 10b, etc.

Access from a wireless mobile terminal T1, for example, is guided to the firewall 11 via a mobile telephone network MN including a wireless network WN, via the public switched network (PSN) DN connected through a router 14 in the wireless network WN, and via another router 12 connected through the public switched network DN. The mobile telephone network MN is managed by a communications service provider that provides communications service by cell phones. The cell phone includes the narrowly defined cellular mobile telephone, as well as PHS.

The wireless mobile terminal T1 is a combination of a mobile terminal such as a notebook computer or a PDA and a cell phone. In the case of a smart cell phone having information-processing capabilities, the wireless mobile terminal T1 consists only of this smart cell phone. The mobile terminal is loaded with a browser program to form a Web browser screen. This browser program may be pre-loaded in the mobile terminal. Alternatively, it may be a Java applet produced by Sun Microsystems, U.S., and may be supplied from the host server 10 whenever a need arises.

As is well known in the art, the mobile telephone network MN is provided with a domain name server (DNS) 30. Similarly, the Internet IN has a global DNS 40. Each of the DNS 30 and the global DNS 40 has an address table describing the relations between domain names and IP (Internet Protocol) addresses. Difference in address when access is implemented can be solved by referring to their mutual address tables.

The private network PN is a communications network consisting of an assemblage of private lines or virtual private lines (lines obtained by making the public switched network virtually private to only concerned parties, for example, using encryption technique and encapsulation techniques). As the private network PN, a so-called next-generation communications network (e.g., a private network known as PRISM) is in a practical stage. Since access points are prepared throughout Japan or globally, the running cost can be reduced by using these access points.

In the present embodiment, local servers 20a and 20b of user enterprises located at remote locations are connected with the private network PN at their closest access points. The local servers are connected with the host servers 10a and 10b, respectively, via this private network PN.

Configuration of Intranet

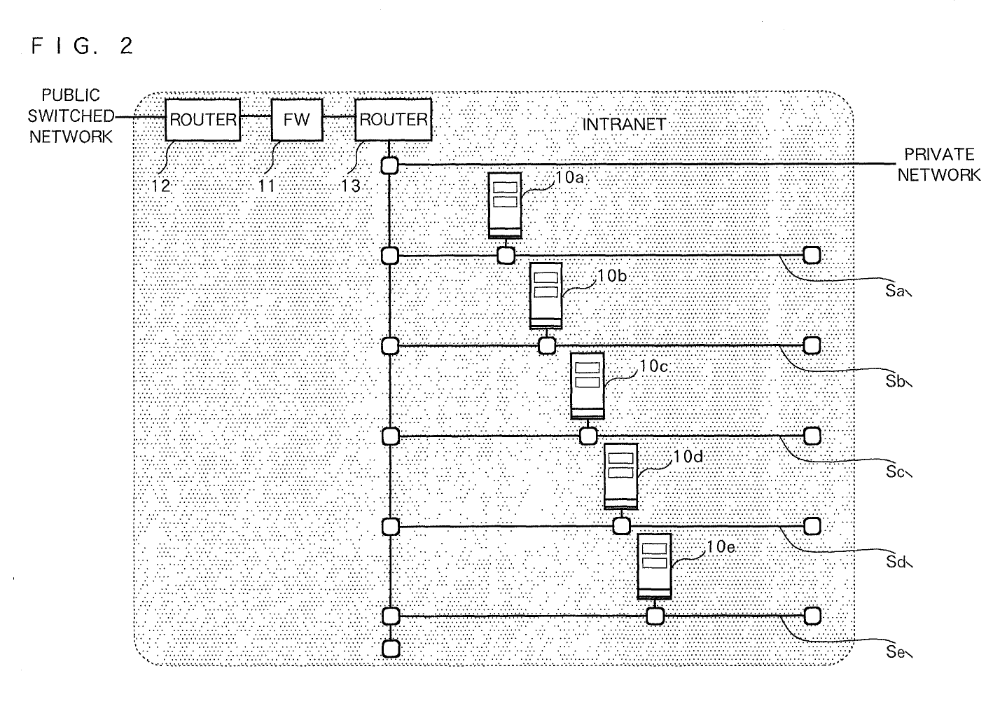

A detail example of the intranet LN is shown in FIG. 2, in which the intranet LN is made up of five segments Sa-Se.

Each segment, e.g., the segment Sa, has plural connection ports one of which is connected with the host server 10a. Another is connected with a router 13 that controls the path inside the firewall 11. Each user enterprise can separately use the segment Sa by connecting certain lines of the private network PN to the port of the router 13.

A switching hub (a smart communication path selector) or a router may be connected between the segment Sa and the private network PN. Connection with the private network PN may be made via this hub or router. The other segments Sb-Se are configured similarly.

The host servers 10a-10e are located at the connection ports of the segments Sa-Se, respectively. If local servers are connected with the host servers 10a-10e via the switching hub 14 and the private network PN, a secure housing is built within the intranet LN.

In particular, all the host servers 10a-10e are connected with their respective local servers via the private network PN and so there is no room for third party's intervention. Because the segments Sa-Se where the host servers 10a-10e are respectively positioned are protected by the firewall 11, it is difficult for an unauthorized person to access the housing. Accordingly, by assigning the individual segments Sa-Se in this housing to user enterprises, the user enterprises can construct secured private network environments or groupware environments at low costs.

Structure of Routers

The routers 12, 13, and 14 control the path at the third layer (network layer) of OSI (Open Systems Interconnection) Reference Model. Since they are connected at the network layer, data can be relayed if the second layer (data link layer) and the underlying layers of the OSI Reference Model are different. Since they also have a function of setting the path, different networks such as the intranet LN and the public switched network DN or the intranet LN and the private network PN can be interconnected.

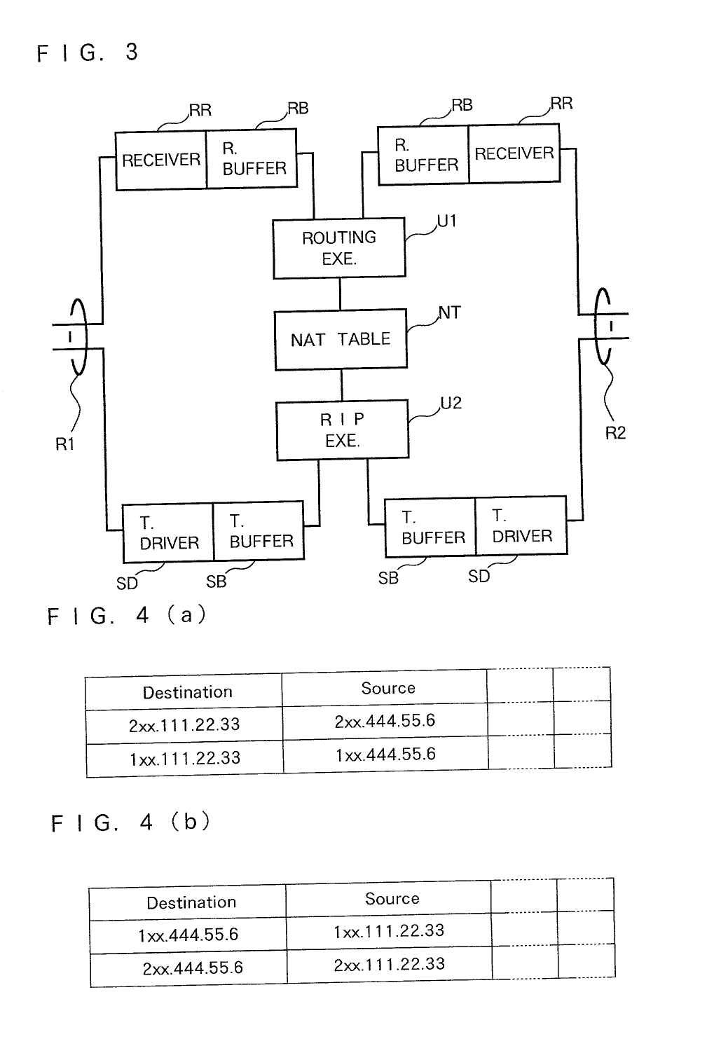

FIG. 3 shows an example of the structure of each router. To perform bidirectional routing, the router places a receiver RR, a reception buffer RB, a sending (transmission) driver SD, and a sending (transmission) buffer SB symmetrically in each of transmission paths R1 and R2. Furthermore, the router has a routing execution portion U1, an NAT (Network Address Translation) table NT, and an RIP (Routing Information Protocol) execution portion U2.

Each receiver RR receives the data from the transmission path R1 or R2. Each reception buffer RB holds received data. Each transmission driver SD sends or routes data to the transmission path R1 or R2. Each transmission buffer SB holds data to be sent or routed. The routing execution portion U1 processes the received RIP, performs an address conversion, and establishes a communication path. The RIP execution portion U2 sends the requisite RIP to the transmission paths R1 and R2. Addresses used during the address conversion, i.e., the address of the destination and the address of the recipient (Source), are placed in the NAT table NT.

FIGS. 4(a) and 4(b) show examples of the contents of the NAT table incorporated in the router 12 outside the intranet LN. FIG. 4(a) shows an example of the NAT table used to route data from the public switched network DN to the firewall 11. FIG. 4(b) shows an example of the NAT table used to route data from the firewall 11 to the public switched network DN. “2xx.111.22.33” indicates the IP address of a local server 20 of a user enterprise whose domain name has been registered. “1xx.111.22.33” indicates the private IP address of the host server 10. “2xx.444.55.6” indicates the IP address of the originator terminal in the Internet. “1xx.444.55.6” indicates the private IP address of the originator terminal that can be recognized by the intranet LN. Access to the intranet LN at an IP address different from that used for access to the Internet is permitted by setting the NAT table as shown in FIG. 4(a) or 4(b).

In the router 13, the address of the originator terminal of access passed through the firewall 11 and the address of the host server to be managed are placed in the NAT table. By setting the NAT table in this way, a communication path control means that selectively establishes a communication path between the originator terminal of the access passed through the firewall 11 and the segment (the host server positioned in it) can be accomplished.

Where a router is used instead of the switching hub 14, addresses are placed in the NAT table in a similar procedure.

Structure of Servers

The host servers (10a, 10b of FIG. 1 and 10a-10e of FIG. 2) and the local servers (20a and 20b of FIG. 1) are described. Note that where it is not necessary to discriminate between the individual host servers, each host server is indicated by 10 without suffix. Similarly, where it is not necessary to discriminate between the individual local servers, each local server is indicated by 20 without suffix.

In principle, one local server 20 corresponds to one host server 10. They are interconnected via the private network PN. Notice that plural local servers 20 can correspond to one host server 10. A unique LAN (Local Area Network) in which one or more client terminals are connected with each local server 20 may be connected. In summary, the servers inside the intranet LN and the servers outside the intranet LN correspond in a 1:1 relation.

The host server 10 is a computer having a Web mail server function capable of forwarding data, a search function, a copying function, and a scheduler function. Furthermore, this computer has a database holding email files, schedule files, and other files. The search function is to search the database for a desired file. The copying function is to activate and execute a copying task for copying the variation in the database with the local server 20. The scheduler function is to manage scheduler files prepared for registered user enterprises, respectively. The local server 20 is a computer having at least the aforementioned copying function and database.

One feature of the present invention is that at least some of files in the databases possessed by the host server 10 and the local server 20 are common files whose contents are maintained in common with each other. If the host server 10 and the local server 20 form groupware, they are common files whose contents are common within the groupware.

For example, the contents of email files and schedule files in the local server 20 directly become the contents of email files and schedule files in the host server 10.

Accordingly, if access to the common files in the host server 10 is gained, this is equivalent to gaining access to the common files managed by the local server 20.

Various conceivable forms can maintain the contents of the common files in the host server 10 and the local server 20 in common with those of the other servers. In this embodiment, the servers perform copying tasks into eachother, thus realizing the maintenance.

In particular, if the common files in the local server 20 vary, the differential data is sent to the host server 10. If differential data is received from the host server 10, the differential data is copied into the common files in this local server. Similar principles apply to the copying tasks of the host server 10.

Form of Operation: Information Access Method

The form of operation of the network system is as follows. As described previously, the segments Sa-Se in the intranet LN are assigned to the host servers of user enterprises to be managed. Therefore, each individual segment can be used by user enterprises.

The form of operation for use in user enterprises can be only the segments Sa-Se. In this case, the user enterprises bring in the host server 10 and the local server 20 corresponding to the host server 10. The form of operation may also be segments Sa-Se in which the host servers 10 having given functions are positioned. The latter case is adapted for the case in which user enterprises already hold local servers 20 corresponding to the host servers 10.

If a user enterprise to be managed, a segment, and the host server 10 located within the intranet LN are determined, then the system administrator registers various conditions (i.e., protocols, data format intrinsic in the system, the address of the host server 10, etc.) under which the firewall 11 allows access from the originator terminal. Furthermore, the address of the host server 10 is registered as the destination and originator terminal (source terminal) within the intranet LN in the address table of the router 13 in the infranet LN. In addition, the address of the host server 10 is registered in a device that is connected via the switching hub 14.

A member (usually, an employee) of a user enterprise manually operates the wireless mobile terminal T1 and gains information access to the desired host server 10 at the IP address (xxxx@xxx.co.jp).

This access is routed from the wireless network WN to the DNS 30 connected with the mobile phone network MN. The DNS 30 gains a global IP address (2xx.111.22.33) for this user enterprise from the global DNS 40, based on the domain name contained in the access, and routes the address to the router 12.

The router 12 refers to the NAT table having contents as shown in FIG. 4(a), converts the global IP address given from the DNS into a private IP address (1xx.111.22.33) for the host server 10. At the same time, the router converts the global IP address (2xx.444.55.6) of the wireless mobile terminal T1 into a private IP address (1xx.444.55.6). Using the routing function, the router sends the access to the firewall The firewall 11 makes a decision as to whether this access meets previously registered conditions. If the conditions are met, the firewall permits passage and sends the access to the router 13. The router 13 encrypts the contents of the access, finds the corresponding segment and host server 10, and sends the access to this host server 10.

The host server 10 searches the common files for data satisfying the request of the access and sends the data back to the router 12 via the router 13 and via the firewall 11.

The router 12 refers to the NAT table whose contents are shown in FIG. 4(b), converts each private IP address into a global IP address, and sends reply data to the wireless mobile terminal T1 via the public switched network DN and wireless network WN, using its routing function.

Copying tasks are carried out between the host server 10 and the local server 20 via the private network PN. The identicalness of the contents of the common files between both is maintained and so the information sent back from the host server 10 is identical in contents with the information held in the local server 20. Therefore, a secure, low-cost system private to an enterprise can be easily realized by making use of this network system.

As one feature, information (email files, schedule files, etc.) held in the local server 20 can be securely obtained from the wireless mobile terminal T1 whose position cannot be located. Therefore, it seems as if the wireless mobile terminal T1 were connected with the local server 20 via a private line. No third party intervenes, which is quite advantageous in treating in-house information.

With this network, it is possible to gain access to in-house information by unified manual operations by storing all information treated by the local server of the head office of an enterprise and by the local servers of the branch offices in common files, managing all the common files by the host server inside the intranet LN, and permitting one to gain access to the common files from the wireless mobile terminal T1 at any time and at any location. This readily realizes a preferred form of operation of groupware in the enterprise.

### APPLICATION EXAMPLE 1

In-House Mailing System

An example of application of the above-described network system is described in detail below. This is an example of an in-house mailing system in which a certain segment of the intranet LN is assigned to a certain user enterprise. Access to in-house information about this user enterprise is implemented using the wireless mobile terminal T1.

E-mails referred to herein embrace various lists of data, edited data, and previously registered various documents, as well as ordinary email messages and documents. The emails are Web mails, and no limitations are imposed on the number of usable characters or the number of stored messages or documents. Documents can be attached to the Web mails. Using the web mails, emails can be exchanged by unified manual operations independent of the kind of machine of the wireless mobile terminal T1.

Since cellular phones that can act as wireless mobile phones having a Web mailing function by themselves such as i-mode terminals offered by NTT DoCoMo, Japan, are widespread, the i-mode terminals are used. However, the mail server is not an i-mode server for i-mode terminals. A Web mail server function offered by the host server 10 is employed. In this way, the default environment of i-mode terminals under which a mailing function is implemented can be used intact. Furthermore, various limitations on usage imposed by the i-mode server, such as the kind of data sent and received, size of the data, and the number of messages, can be eliminated. In addition, the differences between different kinds of machines can be absorbed, and unified manual control environments can be accomplished.

Computers programmed with Domino Server R5 offered by Lotus, U.S., can be used as the host server 10 and the local server 20.

The Domino Server R5 has default functions adapted for execution of the present invention such as a communications function, a mailing function, a server function (especially, HTTP server function), a schedule function, and a copying function. Furthermore, programming for improving the existing functions is permitted. Therefore, it is convenient to use this Domino Server R5.

The Web mail server function adapted for the execution of the present invention (e.g., to edit lists of menu dedicated for in-house emails, to attach information about fees to individual documents or messages, to automatically divide a large size of data received according to the capacity of memory of the recipient before the data is sent out, to display the attached document to a reduced scale on a limited display region of the cell phone, and to limit displayed destinations if there are numerous destinations and to display only their texts) can be easily implemented by adding a separate application program to the default mailing function of the Domino Server R5. Furthermore, a schedule functions (i.e., the present time is constantly monitored, and schedule items prior to the present time are automatically deleted to inhibit these schedule items from being read out) can be readily implemented by adding a separate application program.

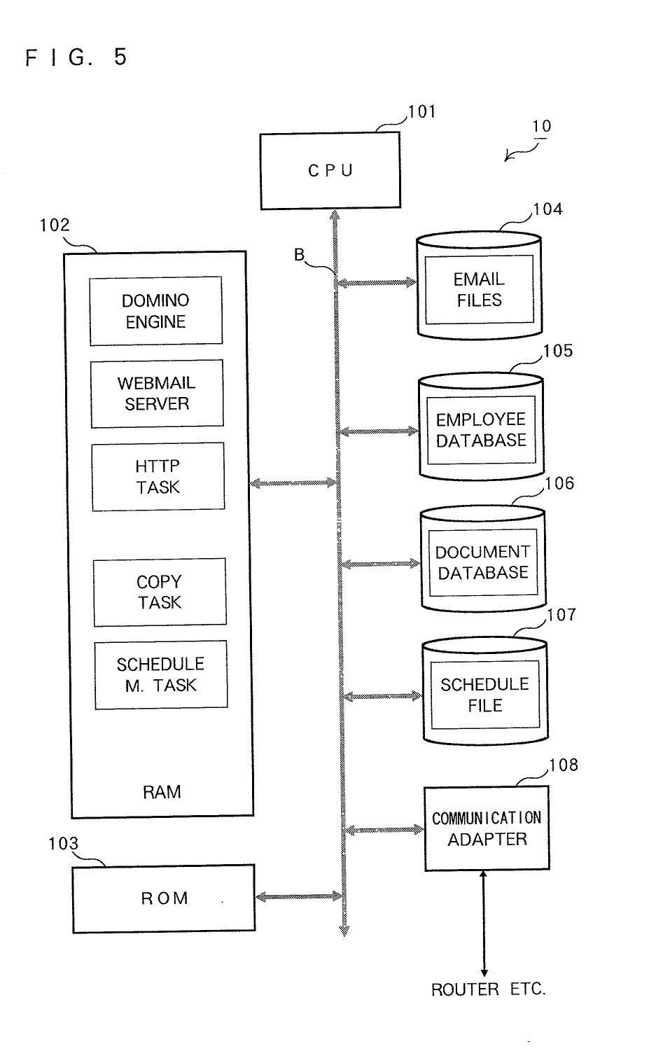

The functions of the host server 10 using the Domino Server R5 are shown in FIG. 5. This host server 10 comprises a CPU 101 operating under control of a given OS, an RAM 102, an ROM 103, email files 104 built in a fixed storage device such as a hard disk that can be read by the CPU 101, an employee database 105 in which an email address book and personal information about the employees are stored, a document database 106 in which HTTP documents are stored, a schedule file 107 in which data about in-house schedules are stored, and a communication adapter 108 for controlling communications with the router 13 and other devices.

Programs for realizing copying tasks, HTTP tasks, and schedule managing tasks as well as a Web mail server function for employees are loaded in the RAM 102, together with a Domino engine unoptionally held by the Domino Server. Control programs including a BIOS (Basic Input Output System) are stored in the ROM 103.

The Domino engine absorbs differences in platform or network OS, offers a unified control environment, and can realize strong document managing functions including integration of documents and search.

On receiving a request for transmission of HTTP from a cellular phone, the HTTP tasks identify a data file corresponding to the request and converts it into an HTML format. Since expanded URLs can be utilized, data files corresponding to the request for transmission of HTTP can be dynamically converted into an HTML format. The local server 20 can also use the Domino server described above.

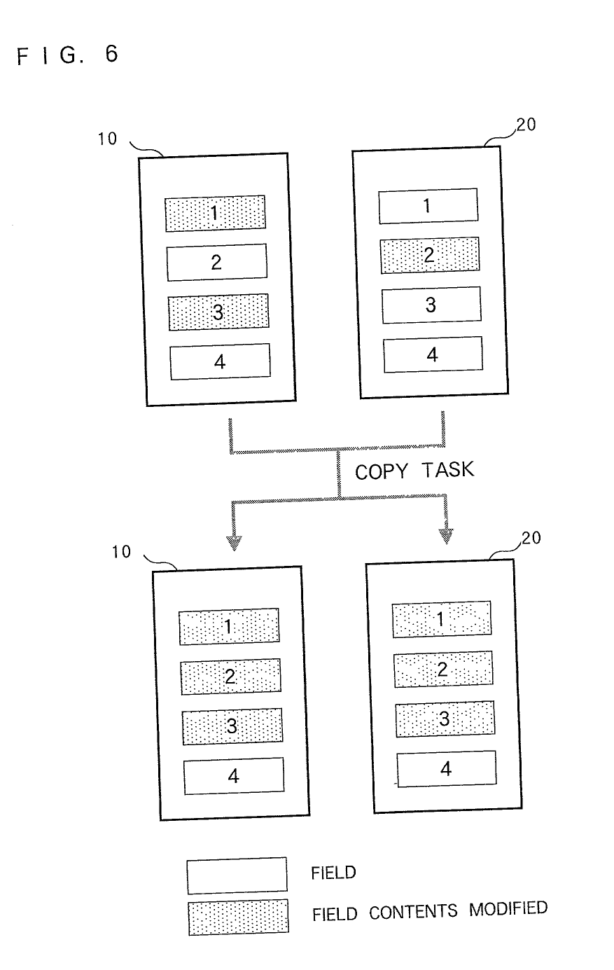

The copying task illustrated in FIG. 6 maintains the common files in common with the host server 10 and the local server 20. In particular, a copying task is activated at regular intervals based on the configuration of each directory. The common files of one local server are compared with the common files in the connected server. If differences are present, differential data are sent to each other and reflected in the mutual common files.

Duplication is done field by field as shown. This is different from ordinary “file copy” in that only modified fields are copied.

The form of usage of the in-house emailing system is described in detail by referring to FIGS. 7-24.

Advance Preparation

A client terminal (not shown) on the side of the local server 20 is previously operated to set an employee ID and a password. The set contents are reflected in the employee database 105 of the host server 10. The set information includes information about authentication done when access to the infranet LN from a cell phone is gained and information about fee. To charge fees for individual groups or company departments, different identification data about the employee ID or password is assigned to a different group. Where a cell phone is used, a fee is charged according to the total amount of data (total amount of packet size) and so data are totalized for each different kind of identification data. The addresses of cell phones are previously held in the employee database 105.

Creation of Address Book for Cell Phone

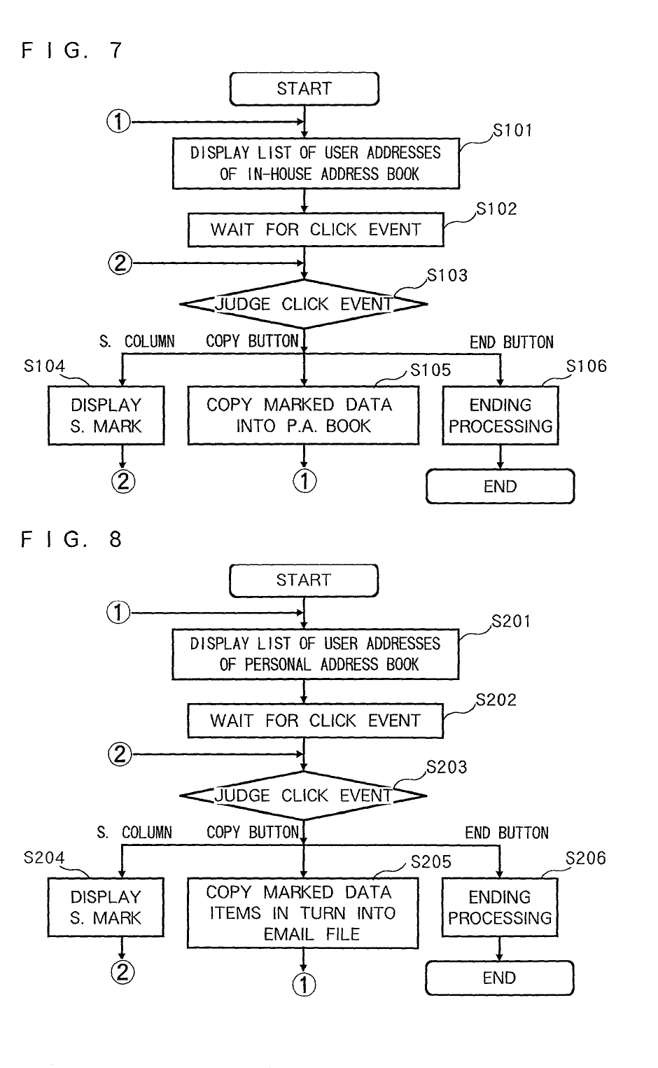

The addresses of about 10 persons are extracted from the in-house address book of the employee database 105 and can be sent to cell phones at any time. This is done on the above-described client terminal in principle. The procedure is illustrated in FIGS. 7 and 8.

Referring to FIG. 7, a list of user addresses in an in-house address book is displayed on the display unit of a client terminal (step 101). The system waits for the occurrence of a click event, i.e., one selected from displayed events by operator's clicking operation (step 102). If such a click event occurs, the contents are judged (step 103).

If the click event is “Selected Column”, a selection mark is displayed before a certain person selected from the list of the user addresses, and control returns to processing of step 103 (step 104). In the case of “Copy Button”, data about the person to which the selection mark is attached is copied into the personal address book, and control goes back to processing of step 101 (step 105). In the case of “End Button”, ending processing is performed (step 106). In this way, a personal address book consisting of the addresses of several persons is created.

Where an address that is used in practice is extracted from the personal address book, processing is performed in a procedure illustrated in FIG. 8. First, the list of the users' addresses of the aforementioned personal address book is displayed on the display unit of the client terminal (step 201). The system waits for the occurrence of a click event (step 202). If a click event occurs, the contents are judged (step 203). If the click event is “Selected Column”, a selection mark is displayed before a certain person selected from the list of the user addresses, and control returns to processing of step 203 (step 204). In the case of “Copy Button”, data items to which selection marks are attached are successively copied into an email file, and control returns to the processing of step 201 (step 205). In the case of “End Button”, the ending processing is carried out (step 206).

The processing for creating an address book for a cell phone by extracting addresses from the in-house address book can also be performed by the cell phone. In this case, however, the addresses are not once copied into the personal address book. Rather, they are directly selected from the in-house address book.

Information Access Method

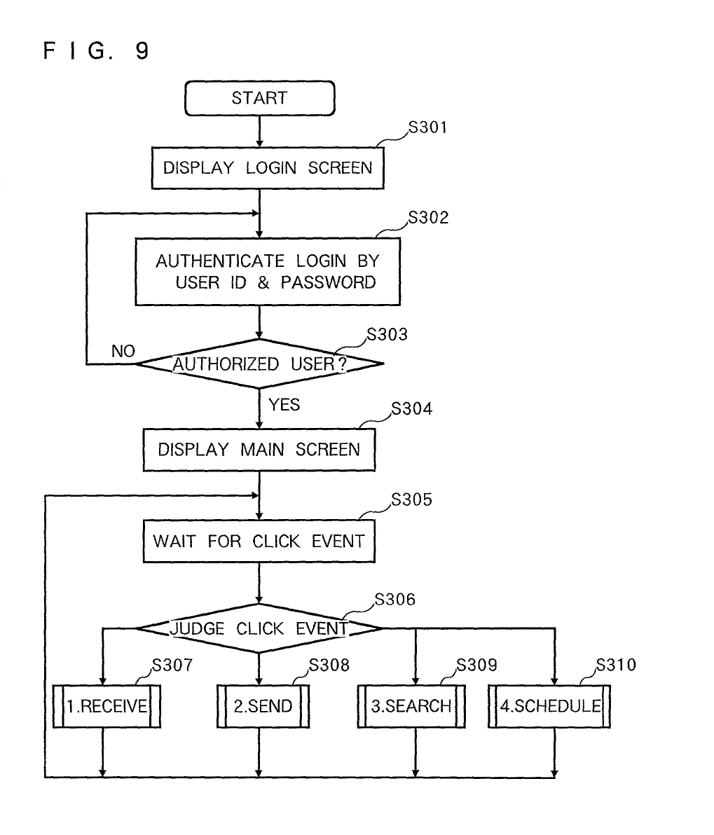

An employee of a user enterprise gains access to the host server 10 from a cell phone in a procedure described below. FIG. 9 is a flowchart illustrating the whole sequence of operations performed for the information access method.

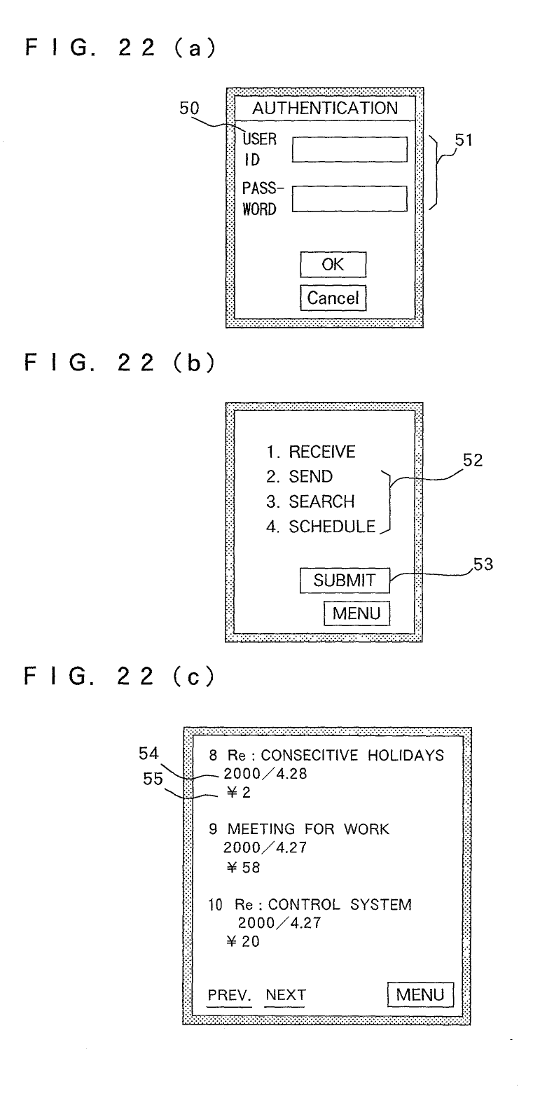

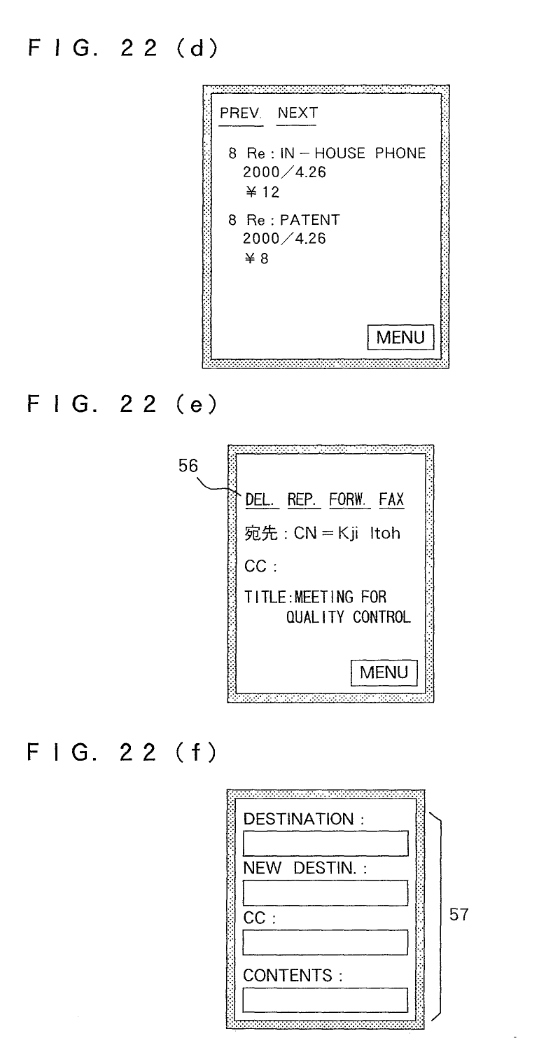

First, a Log-In menu is displayed on the viewing screen of the cell phone (step 301). As shown in FIG. 22(a), the Log-In menu contains a user ID (in this case, an employee ID) and password entry prompt region 51. If they are entered, the log-in is authenticated (step 302). If it fails, control goes back to step 302. A decision is made as to whether the user is authorized (step 303). If authentication is done successfully (i.e., the user is an authorized user), a main screen is displayed (step 304). One example of the main screen is shown in FIG. 22(b) and contains an event selection region 52 for selection of reception, transmission, search, and schedule and a SUBMIT selection region 53.

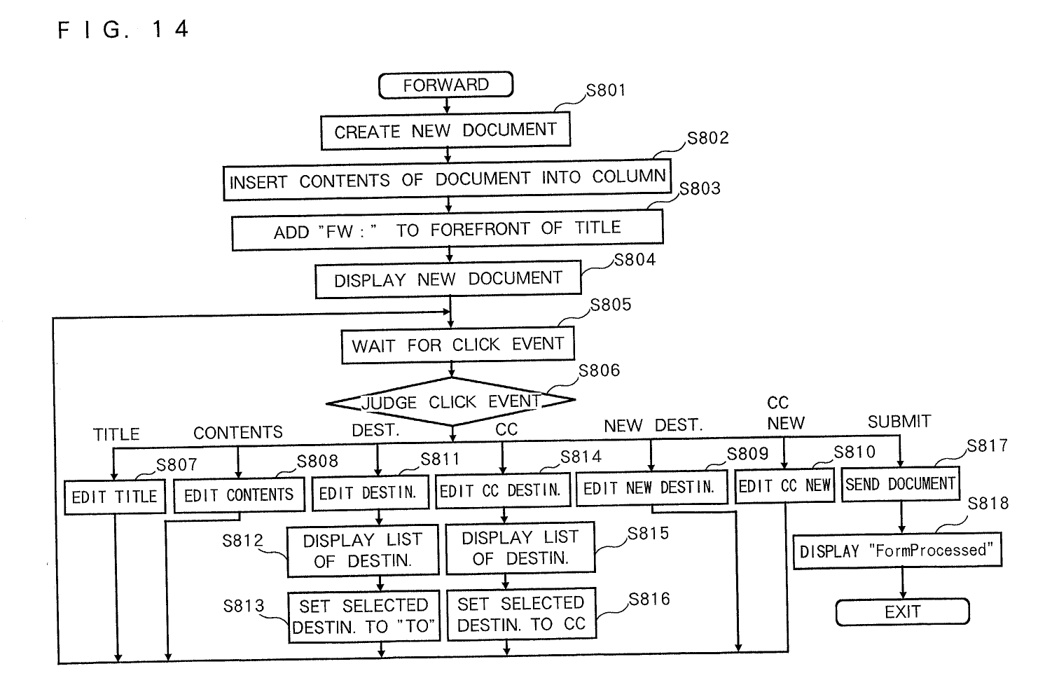

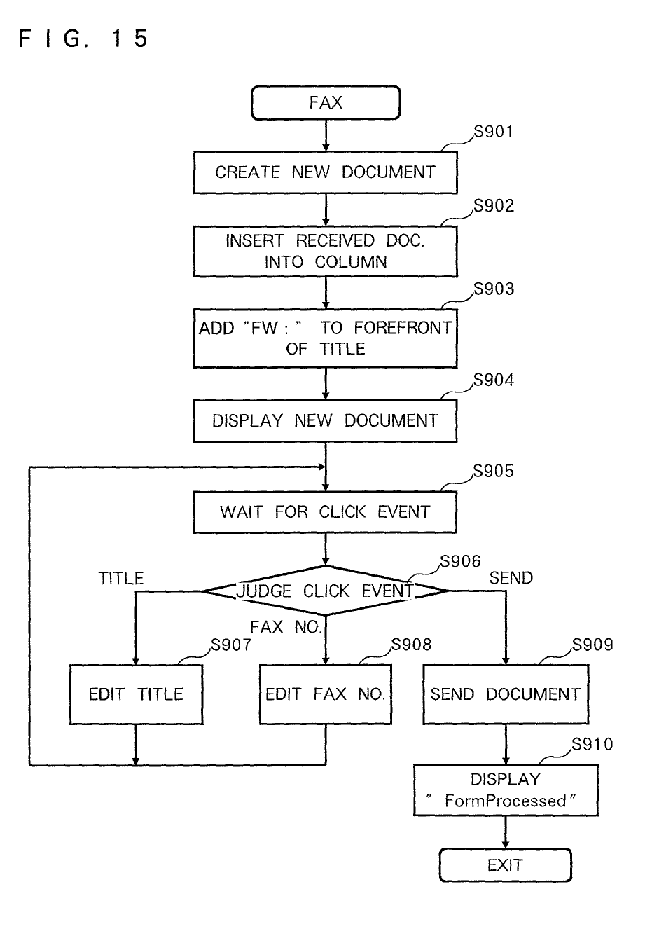

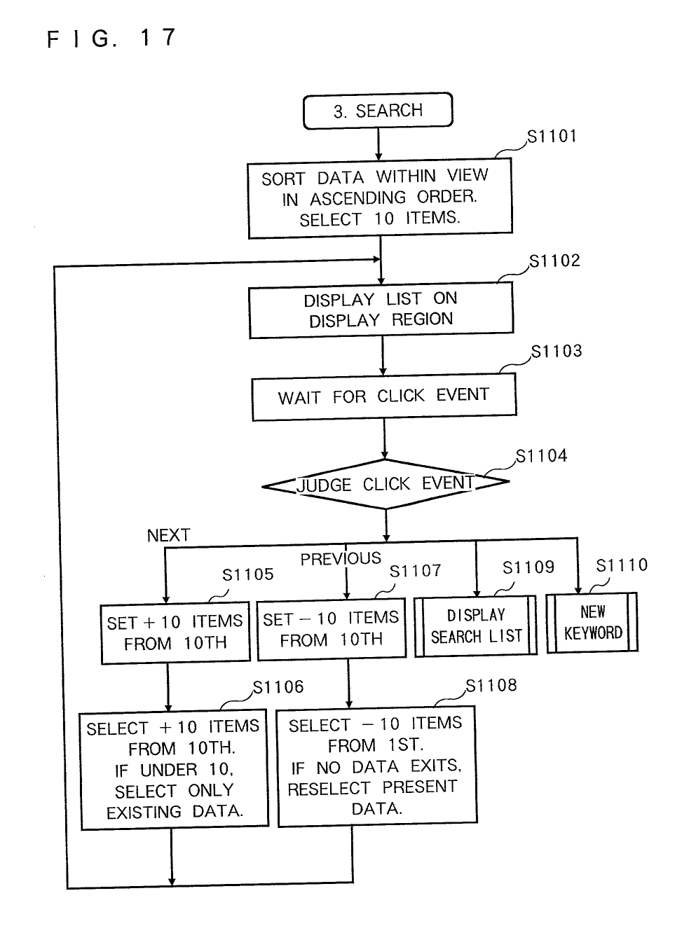

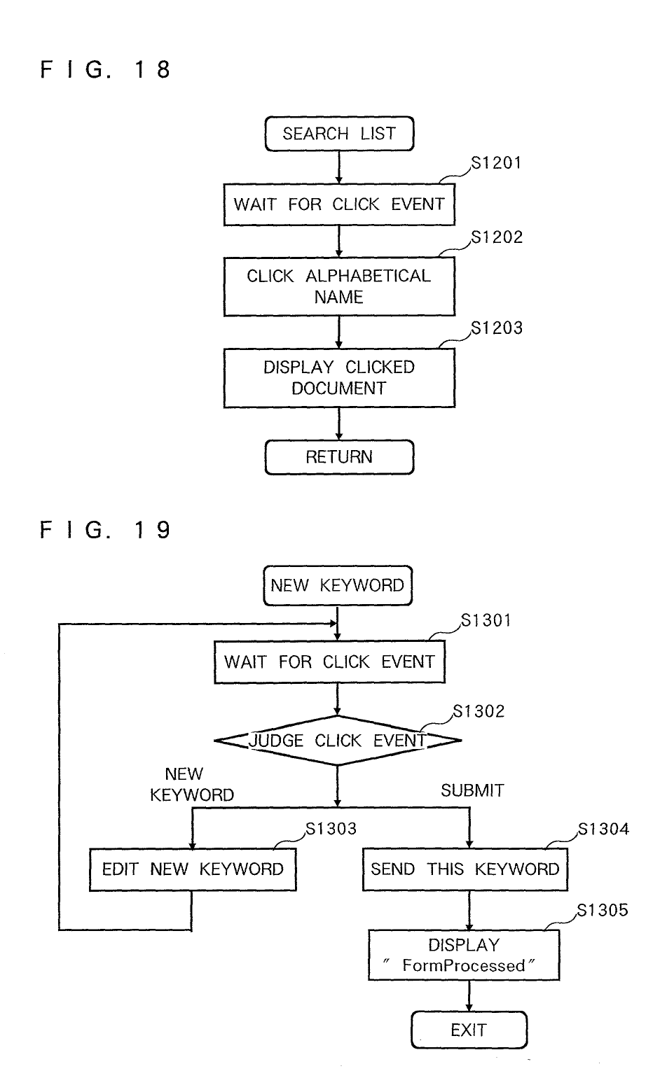

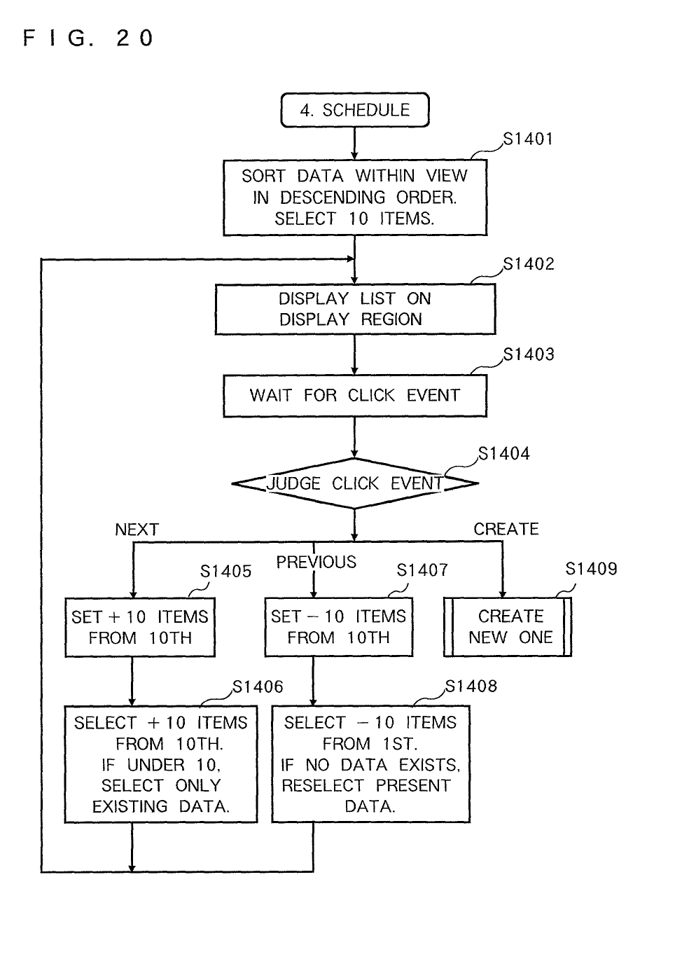

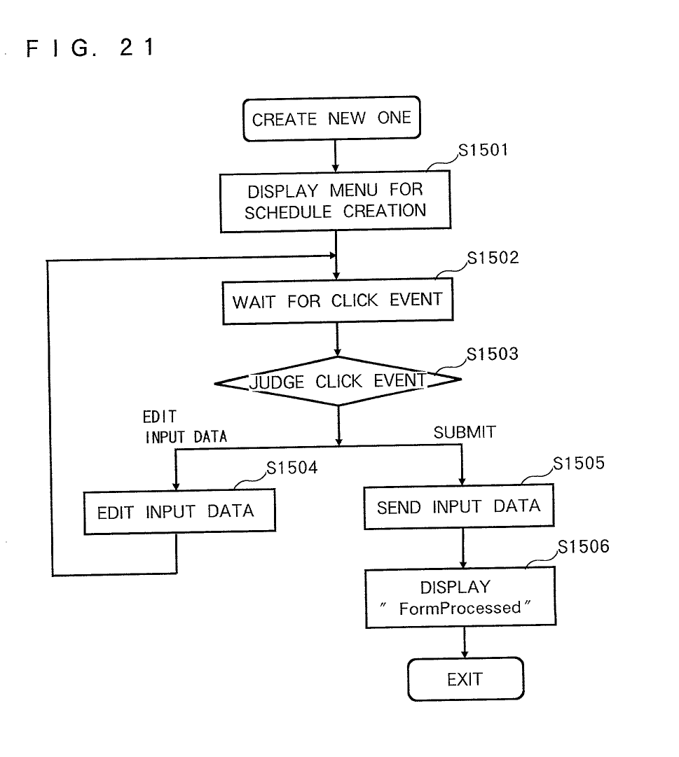

The system waits for the occurrence of a click event (step 305). If it occurs, the contents are judged (step 306). If the click event is “Reception”, reception processing is performed in a procedure illustrated in FIGS. 10-15 (step 307). In the case of “Transmission”, transmission processing is performed in a procedure illustrated in FIG. 16 (step 308). In the case of “Search”, search processing is performed in a procedure illustrated in FIGS. 17-19 (step 309). In the case of “Schedule”, schedule processing is performed in a procedure illustrated in FIGS. 20 and 21 (step 310). If these kinds of processing end, control returns to the processing of step 305. The contents of the reception processing, transmission processing, search processing, and schedule processing are described in detail below.

Reception Processing

The reception processing of step 307 is described. In the reception processing, data are sorted in a descending order according to reception date in the reception box of the cell phone, as shown in FIG. 10. Data numbers are given from 1 such that “+1” is added to the next number (step 401). Ten data items sorted are selected at a time in an ascending order. The first item is set to START (first data number) (step 402). Then, selected data items are displayed on the reception list display region (step 403). This reception list display region includes a pair of regions, i.e., a title region 54 and a fee region 55 indicating information about the fee required for the reception, as shown in FIGS. 22(c) and 22(d). By displaying the information about the fee for the reception in this way, the operator of the cell phone are informed of the size of the data and the cost. The operator of the cell phone (i.e., an employee) views the item title and the fee and can judge whether reading of the item is payable or not. The operator can also estimate the reception time from the fee and judge whether the item should be read immediately or later. A large amount of data (e.g., twenty thousand words) is automatically divided during transmission by the Web mailing function. Therefore, the operator can view a part of the data and refrain from viewing the remaining part of the email. “Previous” and “next” selection buttons are displayed near the bottom of the reception list display region.

The system waits for the occurrence of a click event (step 404). If it occurs, the contents are judged (step 405).

If the click event is “Next”, “+9” is set to START (step 406). Ten items are selected from START. If the START is under 10, only existing data items are displayed (step 407).

If the click event is “Previous”, “−9” is set to START (step 408). Ten items are selected from START. If the START is under 10, “1” is set to START (step 409).

If the click event is “Document Number”, received document displaying processing is performed (step 410).

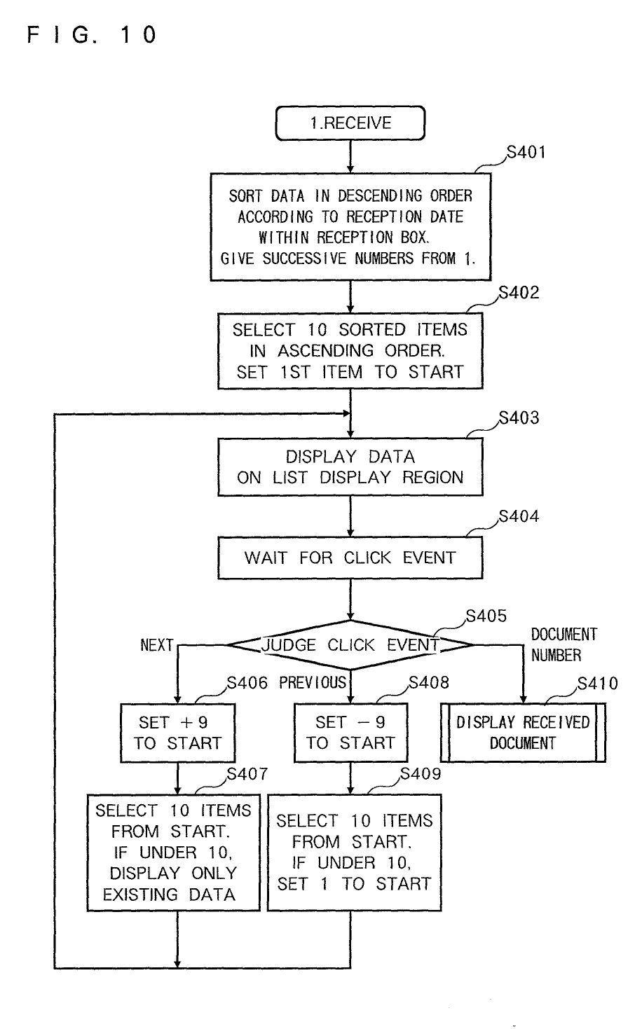

The received document displaying processing (step 410) is particularly illustrated in FIG. 11. If it is sensed that the operator of the cell phone has clicked on a desired document number on the display portion (step 501), the document of the document number clicked is displayed on the display portion (step 503), as shown in FIG. 22(e).

If there is an attached document, a mark indicating the presence is displayed on the display portion by the Web mail server function of the host server 10. Where the attached document is a chart object or bitmap data, it can be displayed as an HTML document according to the size of the display region by clicking on the mark of the attached document.

Assuming that there are many document destinations, the destinations in the frames of the received documents are not displayed. In this way, only the bodies of the documents can be displayed on the display portion of the cell phone. Since information about the destinations is managed from the host server 10, if the user wants to check the destinations from the cell phone, the destinations can be displayed by giving instructions from the browser window having icons or command characters.

In the case of processing of received documents, a selection region 56 containing “Delete”, “Reply”, “Forward”, and “FAX” is displayed near the top of the display portion.

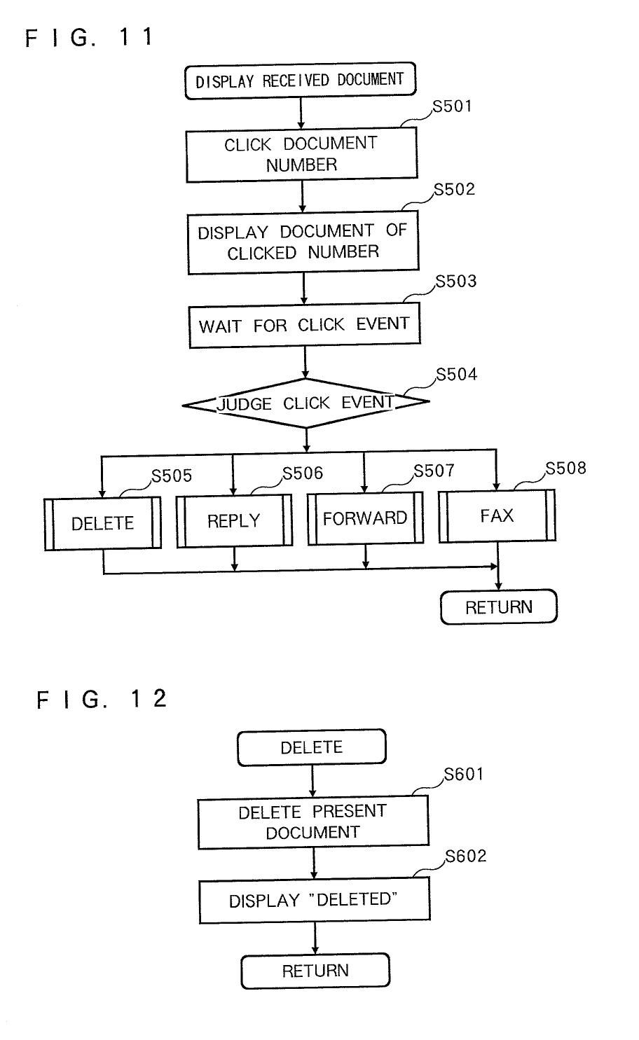

The system waits for the occurrence of a click event (step 503). If it occurs, the contents are judged (step 504). Click events involve “Delete” processing (step 505), “Reply” processing (step 506), and “Fax” processing (step 507).

Where “Delete” is selected from the contents of display shown in FIG. 22(e) during “Delete” processing of step 505, the processing is performed in a procedure illustrated in FIG. 12. The present document is deleted (step 601). “Deleted” is displayed to indicate that the document has been deleted (step 602).

Where “Reply” is selected from the contents of display shown in FIG. 22(e) during “Reply” processing of step 506, the processing is performed in a procedure illustrated in FIG. 13.

First, a new document to be sent back is created (step 701). The sender of the received document is set as the destination (step 702). “Re:” is attached to the forefront of the title name of the received document (step 703). The new document is displayed (step 704).

The system waits for the occurrence of a click event (step 705). If it occurs, the contents are judged (step 706). Where the click event is “Title Name”, title name editing processing is performed (step 707). Where the event is “Contents”, the contents of the document are edited (step 708). Where the event is “New Destination”, new destination editing is done (step 709). Where the event is “CC NEW”, new editing at the CC (carbon copied) location is done (step 710). After the processing, control returns to the processing of step 705.

If the click event judged at step 706 is “Destination”, destination editing processing is performed (step 711). At this time, a list of the destinations of mobile persons (personal address book) is displayed (step 712). Then, the selected destination is set to T0 (step 713). Subsequently, control goes back to the processing of step 705.

If the click event is “CC”, CC destination editing processing is performed (step 714). At this time, a list of mobile person destinations (personal address book) is displayed (step 715). The selected destination is set to “CC” (step 716). Then, control returns to the processing of step 705. If the click event is “SUBMIT”, the corresponding new document is transmitted (step 717). “FormProcessed” is displayed, and the reply processing is ended (step 718).

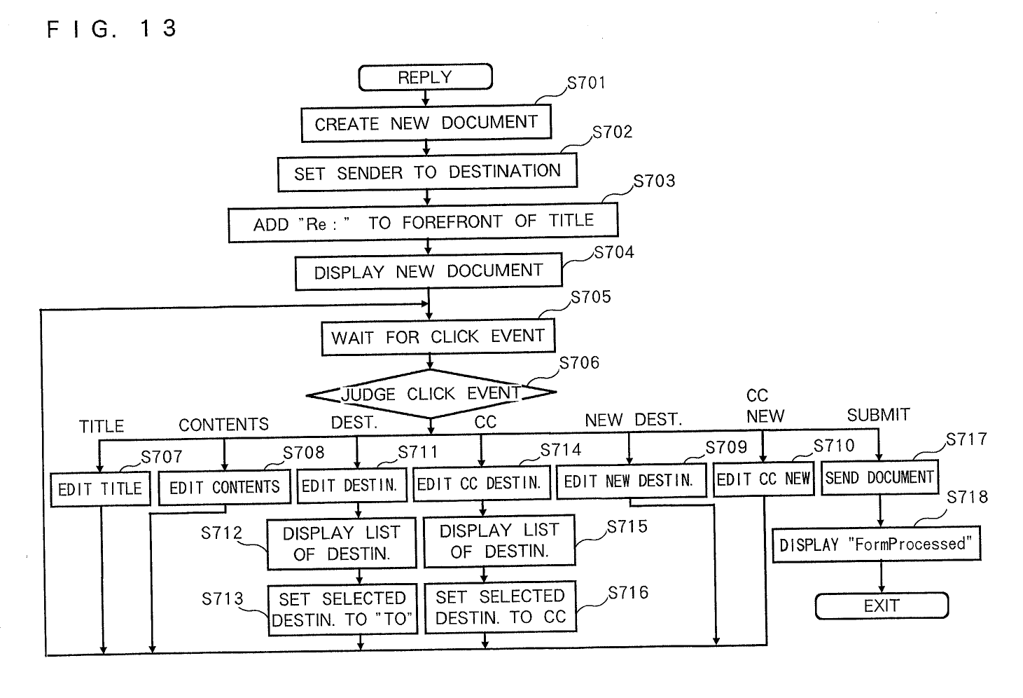

If “Forward” is selected from the contents of display of FIG. 22(e), the “Forward” processing of step 506 is performed in a procedure illustrated in FIG. 14. The contents of processing (steps 801-818) are similar to those of FIG. 13 except that “FW:” is attached to the forefront of the title name of the received document in step 803.

The “FAX” processing of step 507, i.e., the processing performed if “FAX” is selected from the contents of display of FIG. 22(e), is carried out in a procedure illustrated in FIG. 15. First, a new document for Fax is created (step 901). The contents of the received document are placed in the content column (step 902). “FW:” is attached to the forefront of the title name of the received document (step 903). The new document is displayed (step 904).

The system waits for the occurrence of a click event (step 905). If it occurs, the contents are judged (step 906).

If the click event is “Title Name”, title name editing processing is performed (step 907). If the click event is “FAX number”, FAX number editing processing is performed (step 908). After the processing, control returns to the processing of step 905.

If the click event is “Transmit”, this new document is transmitted (step 909). “FormProcessed” is displayed, and the FAX data transmission processing is ended (step 910).

The data transmitted in this way is printed on the FAX machine of the FAX number. The printing on the FAX machine may be realized as one of the functions of the Domino engine. A separate application program for printing on the FAX machine may be loaded in the host server 10, and may be activated as the need arises for printing.

Transmit Processing

Transmit processing of step 308 is next described.

As illustrated in FIG. 16, during the transmit processing, a new document to be transmitted is created (step 1001). The new document is displayed on the display portion (step 1002). Subsequent processing (steps 1003-1016) is similar to the processing of the steps 707-718 (FIG. 13) for reply processing except for the contents of display (FIG. 22(f)) provided on the display portion of the cell phone.

Search Processing

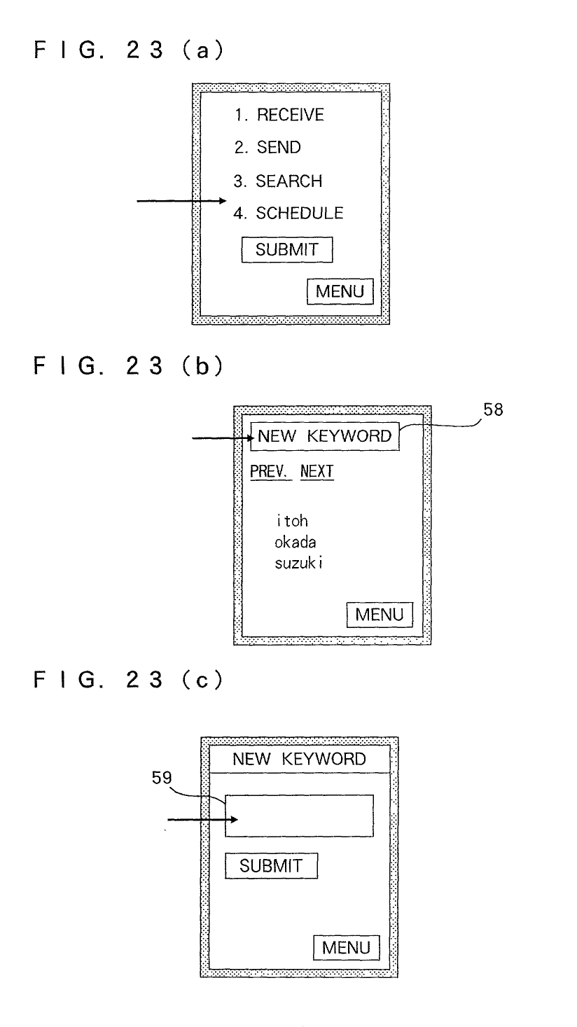

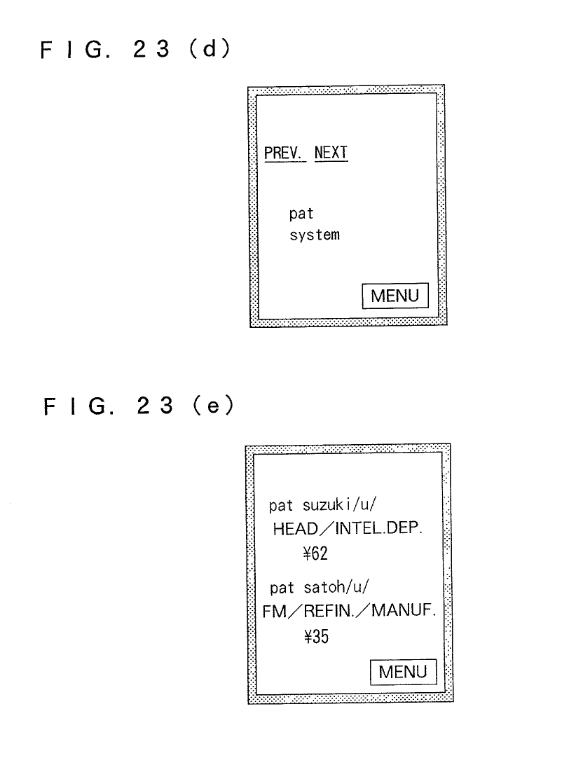

Search processing of step 309 is next described. This search processing is effected where the user selects “Search” as shown in FIG. 23(a). As illustrated in FIG. 17, data items within the search view window are sorted in an alphabetically ascending order, and 10 items are selected (step 1101). Then, a list of the search is displayed on the list display region (step 1102).

The system waits for the occurrence of a click event (step 1103). If it occurs, the contents are judged (step 1104).

If the click event is “Next”, +10 data items from the tenth item on the displayed page are set (step 1105). Then, data about the set items are selected. If the number of data items is under 10, only the existing data items are selected (step 1106). Then, control returns to the processing of step 1102.

If the click event is “Previous”, −10 data items from the tenth item on the displayed page are set (step 1107). Then, data about the set items are selected. If no data are present, data on the present page are reselected (step 1108). Then, control goes back to the processing of step 1102.

If the click event is “Search List Display”, the contents of display on the display portion of the cell phone change from the contents shown in FIG. 23(a) to a list of keywords previously used for search, as shown in FIG. 23(b). In these figures, “itoh”, “okada”, and “suzuki” are keywords used for search.

The procedure for the search list display processing is illustrated in FIG. 18. That is, the system waits for the occurrence of a click event (step 1201). If clicking of an alphabetical name (such as “itoh”) is detected, all documents including the clicked name are displayed (steps 1202 and 1203).

If the click event is “New Keyword”, search processing using a new keyword is carried out. At this time, the contents of display on the display portion change to a window for entry of a new keyword as shown in FIG. 23(c).

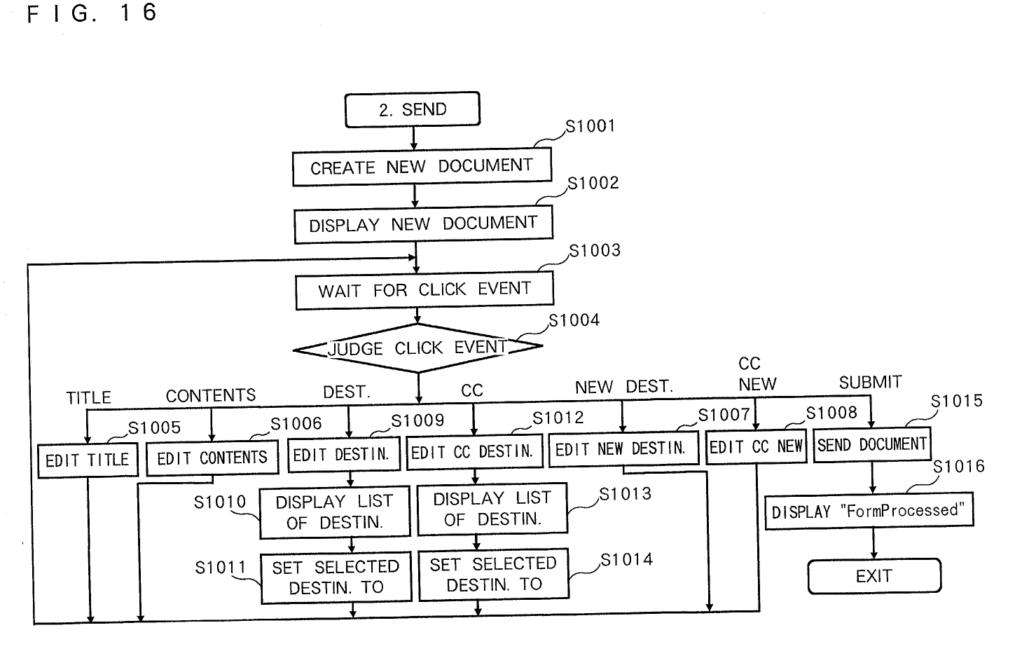

In this case, as illustrated in FIG. 19, the processing is to wait for the occurrence of a click event (step 1301). If it occurs, the contents are judged (step 1302). If the click event is “New Keyword”, new keyword editing is done (step 1301). Control then returns to the processing of step 1301. If the click event is “SUBMIT”, this keyword is transmitted (step 1304). “FormProcessed” is displayed, and the processing is ended (step 1305). If the results of the search are sent from the host server 10, control returns to search list display processing as the need arises. The contents on the display portion change as shown in FIG. 23(d). If an alphabetical word such as “pat” is clicked, all documents including “pat” are displayed as shown in FIG. 23(e).

Schedule Processing

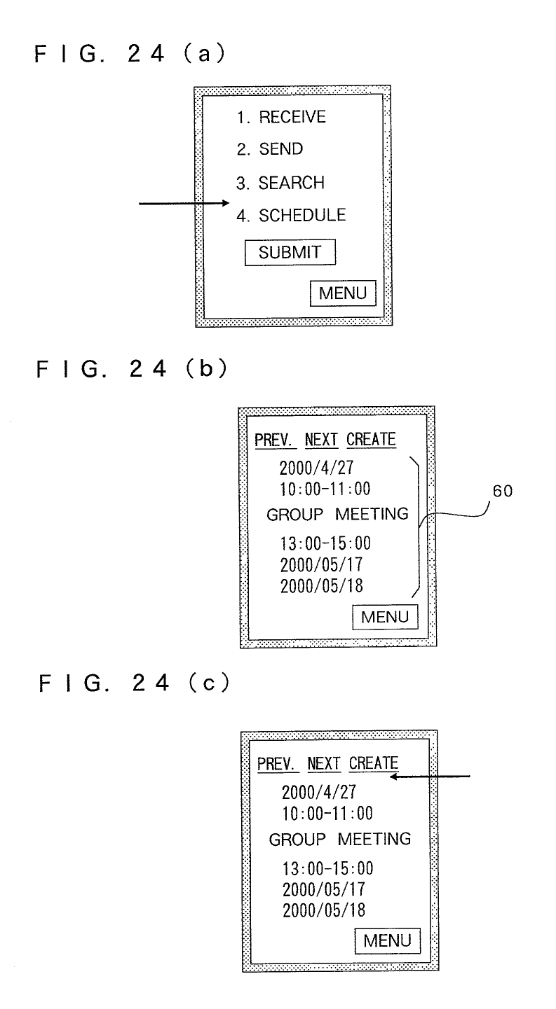

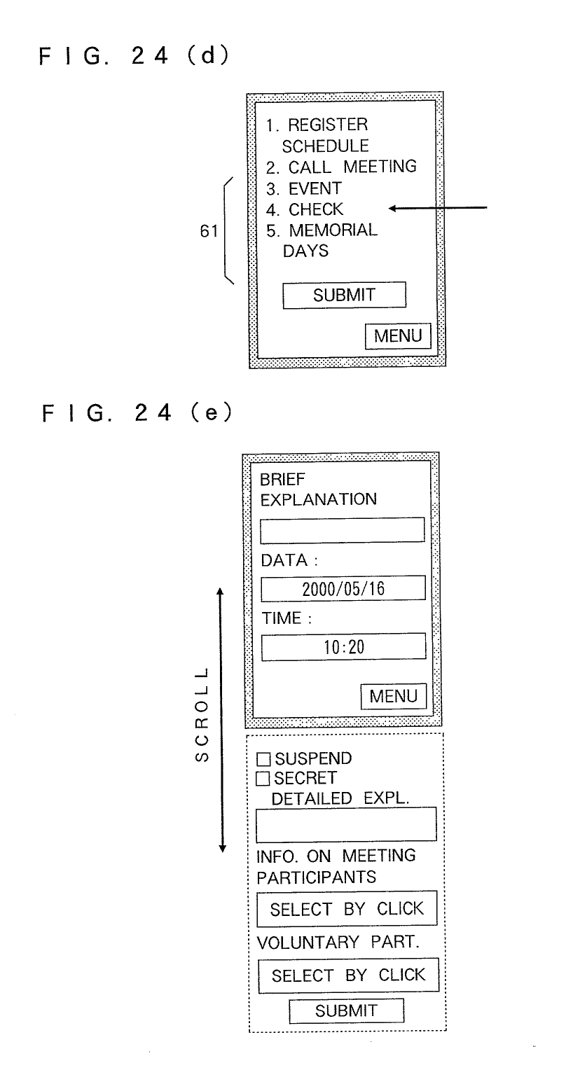

Schedule processing of step 310 is next described. As illustrated in FIG. 24(a), the schedule processing is carried out if the user selects “Schedule”. In this processing, data items within a schedule view window are sorted in a descending order according to date as shown in FIG. 20, and 10 data items are selected (step 1401). Then, a schedule is displayed on the list display region of the display portion (step 1402). FIG. 24(b) shows an example of a list display region 60. If any date is clicked, a time zone set at this date and a brief explanation are displayed. A region for selecting events “Previous”, “Next”, and “Create”, is formed near the top of the display portion.

The system waits for the occurrence of a click event (step 1403). If it occurs, the contents are judged (step 1404).

If the click event is “Next”, +10 data items from the tenth item on the displayed page are set (step 1405). Then, data about the set items are selected (step 1405). If the number of data items are under 10, only the existing data items are selected (step 1406). Then, control returns to the processing of step 1402.

If the click event is “Previous”, −10 data items from the tenth item on the displayed page are set (step 1407). Then, data about the set items are selected. If no data are present, data on the present page is reselected (step 1408). Then, control goes back to the processing of step 1402.

With respect to the data items within the schedule view window, only data items later than the present date are treated. That is, scheduled events after the present date are extracted from the schedule file 107. A list of these scheduled events is created (View in the Domino server) and can be viewed on the cell phone. Consequently, data about scheduled events in the past are prevented from being stored. Hence, efficient use of the memory of the cell phone can be made.

Data about the scheduled events prior to this date and prior to the present time may be automatically deleted from the schedule file 107 of the host server 10. In this case, undesired data items are successively deleted from the schedule file 107. Similarly, undesired data items are deleted from the local server 20. Therefore, effective use of the memory of the host server 10 and the memory of the local server 20 can be made. This assures prevention of leakage of in-house information.

If the click event is “New Creation”, i.e., if “Create” is selected from the contents of display shown in FIG. 24(c), control proceeds to processing for creating a new list of scheduled events. The procedure is illustrated in FIG. 21. In this processing, a menu for creating a schedule is first displayed (step 1501). As shown in FIG. 24(d), this menu for creating a schedule has a region 61 for selecting registration of a scheduled event, calling of a committee, events, check, and memorial days. The user can select any one of them at will.

The system waits for the occurrence of a click event (step 1502). If it occurs, the contents are judged (step 1503).

If a certain menu item is selected from the selection region 61, data are entered and edited (step 1504). Control goes back to the processing of step 1502. If the click event is “SUBMIT”, the entered data is transmitted (step 1505). “FormProcessed” is displayed, and the processing is ended (step 1506). FIG. 24(e) shows the contents of a data entry region 62 when “2. Calling of Committee” is selected. A brief description and times are made to correspond to each date. The data entry region 62 can be scrolled.

Data entered in this way are reflected in the schedule file 107 of the host server 10 and in the local server 20.

As a part of schedule processing or as processing independent of schedule processing, a so-called To Do List function (i.e., a function of managing tasks to be executed and tasks already executed) can be implemented when operated from the cell phone. In this case, this function can be easily realized by adding an application program to the unoptional scheduler function of Domino server R5.

In this way, in the in-house mailing system, one can access the in-house information managed by the host server 10 from a cell phone at any time and at any location. The method of access can assume various forms as described above. It seems as if a user gained access from a fixed terminal inside the intranet LN or from a client terminal of the local server 20. Since the in-house information in the host server 10 is in common with the information in the local server 20 connected via the private network PN, an indirect communication with a person connected with a network to which the local server 20 belongs can be provided. Hence, the groupware can be efficiently run.

### APPLICATION EXAMPLE 2

System for Remotely Operating Application Programs

A network system in accordance with the present invention can be used as a system for remotely operating application programs instead of, or together with, an in-house mailing system.

The configuration of the system is similar to the configuration of an in-house mailing system except for the following points. Given application programs (e.g., a search program for searching an external database different from the common files for desired information, a printing program for automatically printing certain information in the common files, and an automatic control program for automatically controlling in-house clerical devices) are loaded in the local server 20. A manual control window for activating an application program is formed on a browser screen such that a Web mail window is displayed on the display portion of a cell phone, or entry of private commands is permitted.

During operation, a person possessing the cell phone selects a control image, for example, on the browser screen and gains access to the host server 10. The host server 10 encrypts the contents of commands corresponding to the access and sends the contents of the commands to the local server 20, thus activating and running a corresponding application program.

After execution of the application program, the host server 10 gains information about the results of the execution from the local server 20 and sends the gained information to the cell phone.

In this way, exchange of in-house information is enabled. In addition, an in-house application program can be remotely activated from outside by the cell phone. Consequently, a private in-house network system having excellent expansibility can be easily built.

In this embodiment, it is assumed that the network forming the housing is the intranet LN. However, it assumes any form of network as long as it can be protected by a firewall. A housing can be constructed even with an ordinary local network. In the preferred embodiment described above, what passes through the firewall 11 is traffic from the wireless mobile terminal T1 (cell phone). Access from a wireline mobile terminal via the Internet IN, i.e., access from notebook computers and PDAs via a wireline communication network, can be permitted under certain conditions. In this case, however, accesses from unspecified users connected to the Internet IN may be permitted. Therefore, it is to be noted that the load on the firewall 11 is increased.

As can be understood from the description provided thus far, in the present invention, a secured practical private groupware environment can be easily configured. Furthermore, a private in-house network system can be offered at low cost by previously forming a housing having plural segments within a firewalled network and allowing a user enterprise to use this.

What is claimed is:

1. An information access method comprising the steps of:
placing a first server within a network protected by a firewall;
connecting said first server with a second server located outside said network by a private line or a virtual private line;
taking at least some of files possessed by said first server and said second server as common files whose contents are maintained in common with each other; and
permitting information access to the common files in said first server, whereby an originator terminal that implements said access can gain information in the common files of said second server.

2. The information access method of claim 1, wherein said first server has a Web mail server function, and wherein information is exchanged between said first server and a wireless mobile terminal having a Web mailing function by Web mails while using said wireless mobile terminal as the originator terminal.

3. An information access method comprising the steps of:
placing a first server capable of responding to access from a wireless mobile terminal within a network protected by a firewall;
connecting said first server with a second server located outside said network by a private line or a virtual private line;
loading a given application program into said second server;
causing said second server to activate and operate said application program according to commands which are generated by said wireless mobile terminal and which are included in access passed through said firewall; and
sending information about results of operation of said program to said wireless mobile terminal via said first server.

4. The information access method of claim 2 or 3, wherein said wireless mobile terminal is a cellular phone.

5. The information access method of claim 1 or 3, wherein if said network has plural segments independent of each other, said first server is placed in each of said segments, and wherein accesses passed through said firewall are assigned to the first servers specified by said accesses.

6. A network system having a network protected by a firewall, comprising:
segments forming said network and including a first segment;
a first server placed in said first segment and capable of responding to access passed through said firewall;
said first segment having a connection port for connecting said first server with a second server located outside said network by a private line or a virtual private line;
files held in said first and second servers, at least some of said files being common files whose contents are maintained in common with each other; and
said first server acting to search the common files held in this first server for corresponding information in response to said access and to send the fetched information to an originator terminal implemented said access.

7. A network system having a network protected by a firewall, comprising:
plural segments that are independent of each other within said network;
a communication control means mounted within said network to assign access passed through said firewall to any one of said segments;
a first server which is placed in each of said segments and is capable of responding to said access;
each of said segments having a connection port for connecting said first server with a second server located outside said network by a private line or a virtual private line;
files held in said first and second servers in each segment, at least some of said files being common files whose contents are maintained in common with each other; and
one of said first servers receiving said access and acting to search the common files held in this first server for corresponding information and to send the fetched information to an originator terminal implemented said access.

8. The network system of claim 6 or 7, wherein each of said first and second servers is designed so that, if a change in the common files of its own occurs, differential data before and after the change is sent to other server and that, if said differential data is received from the other server, the differential data is automatically copied into the common files of its own.

9. A network system having a network protected by a firewall, comprising:
segments forming said network and including a first segment;
a first server placed in said first segment and capable of responding to access passed through said firewall;
said first segment having a connection port for connecting said first server with a second server located outside said network by a private line or a virtual private line;
said second server being loaded with a given application program;
said first server acting to cause said second server to activate and operate said application program according to commands included in said access, to gain information about results of operation of said program, and to send the gained information to an originator terminal implemented said access.

10. The network system of any one of claims 6-9, wherein said originator terminal is a wireless mobile terminal having a Web mailing function, and wherein said first server having a Web mail server function and responding to access implemented by said wireless mobile terminal by a Web mail.

11. A network system comprising:
a network protected by a firewall;
a first server of a user enterprise placed within said network;
a second server of said user enterprise placed outside said network, said first and second servers being interconnected by a private line or a virtual private line;
files held in said first and second servers, at least some of said files being in-house information files of said user enterprise whose contents are maintained in common with each other;
said network acting to authenticate access from a wireless mobile terminal controlled by an authenticated person;
said first server having a means for executing a copying task for maintaining said in-house information files of its own in common with the contents of said second server; and
said first server further including means for executing at least one of reception processing for receiving information into said in-house information files of its own according to contents of said authenticated access, transmission processing for transmitting information contained in said in-house information files of its own, information search processing, and schedule processing for reading or entering an in-house schedule contained in said in-house information file of its own, whereby permitting communication with said wireless mobile terminal implementing said access.

12. The network system of claim 11, wherein said first server further includes a means for assisting transfer of information in the in-house information files among members of said user enterprise including said authenticated person.

13. The network system of claim 11, wherein said first server further includes a means for creating a mobile address book which consists of addresses of a given number of persons extracted from an employee address book of said user enterprise and which will be presented on said cell phone.

14. The network system of claim 11, wherein said first server has a time-measuring means, and wherein when said schedule processing is performed, only data about scheduled events later than the present date or present time are subjected to said schedule processing.

15. The network system of claim 11, wherein
(A) said wireless mobile terminal is a cellular phone having a Web mailing function,
(B) said first server has a Web mail server function and responds to access from said cellular phone by a Web mail, and
(C) information about a fee required for reception is displayed on said cellular phone for each different kind of information to be processed.

16. The network system of claim 15, wherein said first server is designed to limit displayed information about destinations included in a document displayed on said cellular phone.
